(19) United States
(12) Patent Application Publication
(10) Pub. No.: US 2016/0245757 A1
(43) Pub. Date: Aug. 25, 2016

(54) A Method of Controlling Hydrophobic Contaminants by Utilizing a Fluorescent Dye

(71) Applicant: ECOLAB USA INC., St. Paul, MN (US)

(72) Inventor: Qing Qing Yuan, Shanghai (CN)

(73) Assignee: Ecolab USA Inc., St. Paul, MN (US)

(21) Appl. No.: 15/025,658

(22) PCT Filed: Sep. 25, 2014
(86) PCT No.: PCT/US2014/057384

§ 371 Date: Mar. 29, 2016

(30) Foreign Application Priority Data
Sep. 29, 2013 (CN) 201310453255.9

(51) Int. Cl. G01N 21/94; D21C 9/08; G01N 21/64

(52) U.S. Cl. CPC G01N 21/94; G01N 21/643; D21C 9/08; G01N 2021/6439

(57) ABSTRACT

The present invention pertains to a method of determining the quantity of hydrophobic contaminants in a papermaking process by utilizing a fluorescent dye, to a method of evaluating treatment chemicals for controlling hydrophobic contaminants by utilizing a fluorescent dye, and to a method of optimizing the amounts of treatment chemicals for reducing hydrophobic contaminants in a papermaking process by utilizing fluorescent dye.

### FIELD OF THE INVENTION

The present invention pertains to a method of determining the quantity of hydrophobic contaminants in a papermaking process by utilizing a fluorescent dye, to a method of evaluating treatment chemicals for controlling hydrophobic contaminants by utilizing a fluorescent dye, and to a method of optimizing the amounts of treatment chemicals for reducing hydrophobic contaminants in a papermaking process by utilizing fluorescent dye.

### BACKGROUND OF THE INVENTION

Hydrophobic organic contaminants, such as wood pitch, stickies, and white pitch, are one of the major obstacles in papermaking processes, because they can form deposits that hurt machine runnability and paper product quality. Increased use of secondary fiber, coated broke and mechanical pulp of high yield, and increased cycling of white water through modern high-speed machine system, contribute to large accumulation of the hydrophobic contaminants in papermaking machine system. Therefore, it becomes more essential for papermakers to design a proper contaminants-controlling program before deposits burst out seriously.

At present, there is no unified standard for the concrete classification of contaminant particles in papermaking field. Nevertheless, the contaminants can be generally classified into three size catalogues macrostickies (with a size of more than 100 or 150 μm), colloidal substance (with a size of less than 10 μm), and microstickies (with a size between macrostickies and colloidal substance) [Wang Shuangfei, Luo Lianxin, “Stickies Deposit and Control in Secondary Fibers Recycling”, China Light Industry Press, 2009: p 15]. Different from the fact that macrostickies can be easily removed by washing or by mechanical processes with a pressurized sieve or a centrifugal slag separator or other mill equipments, it's more popular to control smaller-sized contaminants like microstickies and colloidal substance through chemical treatments. In principal, the microstickies and colloidal substance can be reduced in the system by chemical treatments in two typical mechanisms, either effluent discharge/waste rejection in form of particle suspension in aqueous system (a.k.a. dispersion and detackification), or retention in final sheet with fibers (a.k.a. fixation) allowing the contaminants to be taken away via paper product from papermaking machine. More often, a combination of chemical treatments in different mechanisms is requested together (but treatment chemicals applied independently) in a papermaking process to maximally reduce the overall content of contaminants. Historically, versatile methods have been developed to monitor organic contaminants in papermaking process, e.g. microscopic mapping, handsheet stickies/dirt image analysis (ex. Pulmac's Master Screen™ and FPInnovations Autospeck™), flow cytometry (ex. Kemira Flyto™), and more recently online Optical Macrostickies Monitor (see ex. US Patent Application 2012/0258547), etc. However, a rapid and accurate method of screening the efficacy of different chemical treatments is still desired in the market, as well as an overall control program utilizing this method for optimizing dosages of the dispersants/detackifiers/fixatives.

For example, filtrate turbidity reduction is a common method used to assess the performance of fixatives in paper mills; but on the contrary, turbidity increase is also suggested for performance evaluation of dispersants in certain cases. Besides, this turbidity method is believed not entirely adequate to individualized characterization of the foregoing hydrophobic organic contaminants, because it is directed to all particles contained in the aqueous system as a whole. For that reason, various treatment chemicals are often evaluated and the control program is often determined by the papermakers only in field trails. It means intensive labor and capital, and on other hand, it may probably increase extra burden on the running paper machine.

Recently, a fluorescence measurement technology was developed for monitoring hydrophobic contaminants in papermaking processes. For example, the US patent application No. 2010/0236732 discloses a method of monitoring and controlling one or more types of hydrophobic contaminants in a papermaking process, which employs a dye that is capable of interacting with said contaminants and fluorescing to monitor said contaminants and to assess the efficacy of treatment chemicals. However, the US patent application No. 2010/0236732 only generally correlates the fluorescence with the concentration of hydrophobic contaminants in the fluid, rather than setting forth a more specific method of determining and controlling the contaminants within specific size ranges (thereby employing different chemical treatments). Thus, it does not have any practical significance to guide the paper mills to design an overall chemical program to control contaminants.

Since then, intensive practices have been taken to utilize fluorescent dye solely to measure the effectiveness of fixatives on various pulp grades, e.g., cf. the following three documents:
1. Laura M. Sherman, Michael J. Murcia, Ruedi Jenzer, and Alessandra Gerli, “Advanced control of hydrophobicity contaminants in the paper machine wet end.” TAPPI PaperCon, 2009.
2. Qun Dong, Qing Qing Yuan, Sergey M. Shevchenko, Laura M. Sherman, Jun Hai Lin, Yu Mei Lu, Zhi Chen, and Jian Kun Shen. “Application of fluorescene technology in monitoring hydrophobic contaminants in paper & pulp process.” 16^{th} International Symposium on Wood, Fiber and Pulping Chemistry—Proceedings, ISWFPC, 2011.
3. Qun Dong, Qing Qing Yuan, Anuj Verma, and Sugiono Tamsil. “Novel and versatile fluorescene application in monitoring hydrophobic contaminants in paper & pulp process.” PaperASIA, 2012.
   But the true advantages of fluorescence technology are still believed not found out yet through these references. The fluorescent dye can be utilized by the innovative means of evaluating not only fixatives, but dispersants and detackifiers at meantime too. Therefore, it can benefit the accurate designing of a cost-effective overall chemical treatment program, and reduce the amount of hydrophobic contaminants to the minimum.

### SUMMARY OF THE INVENTION

Based on the above prior art, the object of the present invention is to design a more efficient and practical determining and processing method by utilizing a fluorescent dye, with which said dye can be specifically used not only to detect the quantities and the corresponding percentages of hydrophobic contaminants in a pulp slurry and an aqueous suspension, particularly microstickies and colloidal substance, thereby allowing suitable treatment chemicals to be rapidly and accurately selected out, but also to optimize the dosages of various treatment chemicals such as fixatives, dispersants and detackifiers when used in combination.

Therefore, a first aspect of the present invention is to provide for a method of determining the quantity of hydrophobic contaminants in a papermaking process by using a fluorescent dye, comprising the steps of: a). obtaining a pulp slurry or an aqueous suspension containing hydrophobic contaminants from paper- & pulp-making process; b). subjecting the pulp slurry or aqueous suspension to at least primary large particle filtration and/or secondary fine filtration, and collecting the respective filtrates; c). selecting a fluorescent dye that is capable of interacting with said hydrophobic contaminants and fluorescing; d). adding said dye to said pulp slurry, aqueous suspension and/or filtrates, and allowing said dye to interact with said hydrophobic contaminants; e). measuring fluorescence of said dye and correlating said fluorescence with quantity of said hydrophobic contaminants so as to determine the amounts of said hydrophobic contaminants within the corresponding size ranges.

A second aspect of the present invention is to provide for a method of determining the chemical treatment for controlling hydrophobic contaminants by using fluorescence technology, comprising the steps of: a). obtaining a pulp slurry or an aqueous suspension containing hydrophobic contaminants from paper- & pulp-making process; b). subjecting the pulp slurry or aqueous suspension to at least primary large particle filtration and/or secondary fine filtration, and collecting the respective filtrates; c). selecting a fluorescent dye that is capable of interacting with said hydrophobic contaminants and fluorescing; d). adding said dye to said pulp slurry, aqueous suspension and/or filtrates, and allowing said dye to interact with said hydrophobic contaminants; e). measuring fluorescence of said dye and correlating said fluorescence with quantity of said hydrophobic contaminants so as to determine the amounts of said hydrophobic contaminants within the corresponding size ranges; f). optionally performing chemical treatment including dispersion, detackification and/or fixation according to the obtained quantities of individual hydrophobic contaminants.

A third aspect of the present invention is to provide for a method of optimizing the dosages of treatment chemicals for reducing the overall quantity of hydrophobic contaminants by using fluorescence technology, comprising the steps of: a). obtaining a pulp slurry or an aqueous suspension containing hydrophobic contaminants from paper- & pulp-making process; b). subjecting the pulp slurry or aqueous suspension to at least primary large particle filtration and/or secondary fine filtration and collecting the respective filtrates; c). selecting a fluorescent dye that is capable of interacting with said hydrophobic contaminants and fluorescing; d). adding said dye to said pulp slurry, aqueous suspension and/or filtrates and allowing said dye to interact with said hydrophobic contaminants; e). measuring fluorescence of said dye and correlating said fluorescence with quantity of said hydrophobic contaminants so as to determine the amounts of said hydrophobic contaminants within the corresponding size ranges; f). adding one or more treatment chemicals for chemical treatment including dispersion, detackification and/or fixation to said pulp slurry, aqueous suspension and/or filtrates; g). repeating steps a)-e) for at least one time, to re-determine the quality change of various contaminants in said pulp slurry, aqueous suspension and/or filtrates, and then optionally controlling and adding said one or more treatment chemicals for chemical treatment including dispersion, detackification and/or fixation with a changed amount to said pulp slurry, aqueous suspension and/or filtrates.

The method of the present invention, which utilizes the fluorescence technology to select chemical treatments for controlling hydrophobic contaminants in a papermaking process, is simple, accurate and practical. In addition, the method of the present invention can optimize and reduce the overall amount of treatment chemicals by optimizing different treatment chemicals combinations, and thus is highly efficient, environmentally friendly and economical.

Other aspects and variations as well as other advantages of the present invention can be clear from the following detailed description of the specification and the appended claims.

### DETAILED DESCRIPTION OF THE INVENTION

The following terms are applied in the context of the present invention:

The term “papermaking process” means a method of making any kind of paper products (e.g. newsprint, printing paper, fine paper, linerboard, corrugated boxes, thin tissue paper) from paper fibers, comprising forming a base papermaking furnish from plant fibers, draining an aqueous suspension comprising the furnish and other non-cellulosic auxiliary material (i.e., papermaking chemicals) to form a sheet, and then drying, surface treating and rolling the sheet etc. The steps of forming the papermaking furnish from plant fibers, draining and drying as well as calendering may be carried out in any manner generally known to those skilled in the art.

The term “hydrophobic contaminants” means organic substances including wood resin, stickies and white resin and the like in papermaking industry. Typical wood resin contaminants may include for example fatty acids, resin acids and unsaponifiables thereof liberated from wood, and fatty acid esters formed by glycerol and sterol therewith, as well as defoaming agent, rosin, coating and some ingredients in alkaline sizing agent and so on as are introduced during pulping process. Typical stickies contaminants may be for example hot melt adhesive, pressure sensitive adhesive, coating adhesive, residual ink, wax and wet strength resin and the like as originated from recycled fibers. Typical white resin contaminants may be for example coating adhesive originated from coated broke and other complicated organics similar to natural resin existing in paper material. In addition, white resin generally comprises inorganic ingredients such as calcium carbonate.

Due to the complexity of the composition and source of the contaminants, the contaminant particles are generally classified according to their physical size. The contaminants are usually roughly divided into the following three categories according to the longest dimension of the particles: macrostickies (with a size of more than 150 μm), colloidal substance (with a size of less than 10 or 20 μm), and microstickies (with a size between macrostickies and colloidal substance). Different from the fact that macrostickies can be easily removed by washing or by mechanical processes with a pressurized sieve or a centrifugal slag separator or other equipments, smaller-sized contaminants such as microstickies and colloidal substance are usually subjected to chemical treatments of dispersion, detackification and/or fixation using treatment chemicals. The term “contaminants” used herein especially includes, but not limited to, microstickies and/or colloidal substance that are removed in virtue of chemical treatments.

As to the preceding contaminants, without any chemical pretreatment, they generally require at least two filtration steps so as to effect a targeted size fractionation of various contaminants according to different sizes of the particles. The terms “primary large particle filtration” and “secondary fine filtration” are usually adopted to represent two filtration steps for the contaminants with different particle sizes. For example, a papermaking process generally comprises two filtration steps, one of which is performed in the pulp screening process using e.g. a pressurized sieve to discharge large contaminant particles together with other large impurities and debris as sieve residue, and the other of which is performed in sheet formation and draining process to trap small contaminants via pores of fibrous web layer formed in the sheet while the remaining finer particles are returned back and enriched in the cycled white water. Correspondingly, when the present invention refers to a papermaking process, the terms “primary large particle filtration” and “secondary fine filtration” are used to represent two filtration steps directed to the contaminants with different particle sizes in the papermaking process. It should be understood that the mesh sizes in relation to the terms “primary large particle filtration” and “secondary fine filtration” herein are not strictly corresponding to the classification sizes of the contaminants as set forth at the beginning of the description. A person skilled in the art could select suitable filter mesh size for the primary large particle filtration and the secondary fine filtration according to the actual production experiences and the source and composition of the contaminants, as long as they are capable of separating the contaminant particles having significantly different sizes. In one embodiment, the difference in the filter mesh size for these two filtration steps may be e.g. greater than 30 μm, or greater than 60 μm, or even greater than 100 μm, and in particular greater than 150 μm. If necessary to further subject the contaminants to a further fine filtration step, a person skilled in the art can carry out a subsequent filtration process using a smaller mesh size than that in the secondary fine filtration (as long as the size difference lies in an operation-suitable range) until achieving the desired effect. The filtration operation and the filtration material are not important per se. A person skilled in the art may employ various experimental filtration materials known in prior art. In one embodiment of the present invention, the primary large particle filtration can be carried out using a flat sieve, such as Pulmac sieve, Valley sieve, Somerville sieve, Haindl sieve, Packer sieve, preferably a filter sieve with the mesh size or slit size ranging from 100 mesh to 200 mesh (i.e., from 150 to 76 μm). In one embodiment of the present invention, said secondary fine filtration can be carried out using a quantitative or qualitative filter paper, preferably an ashless quantitative filter paper with the mesh size ranging from 10 to 30 μm. In one embodiment of the present invention, the secondary fine filtration can be carried out using a microporous filtration membrane, preferably with the mesh size ranging from 5 to 20 μm.

In the context of the present invention, the term “fluorescent dye” refers to any dye capable of interacting with the contaminants in the filtrate and simultaneously fluorescing, especially lipophilic ones, for example, Nile red, dansyl amine, pyrene, 1-pyrene formaldehyde, 2,6-diphenyl-4-(2,4,6-triphenyl-1-pyridinium)phenolate, 4-aminophthalimide, 4-(N,N-dimethylamino)phthalimide, bromonaphthalene, 2-dimethylamino naphthalene, and combinations thereof.

The term “treatment chemicals” includes any reagent that is suitable for various chemical treatments and useful for reducing the amount of contaminants. In the context of the present invention, treatment chemicals especially includes, but not limited to, dispersants, surfactants, detackifiers, fixatives and retention aids. Directed to different contaminant particles and chemical treatments (such as dispersion, detackification or fixation), different treatment chemicals are usually used respectively. These treatment chemicals are usually well known to a person skilled in the art.

As described above, in the first aspect, the present invention relates to a method of determining the quantity of hydrophobic contaminants in a papermaking process by using fluorescent dye, comprising the steps of: a). obtaining a pulp slurry or an aqueous suspension containing hydrophobic contaminants from paper- & pulp-making process; b). subjecting the pulp slurry or aqueous suspension to at least primary large particle filtration and/or secondary fine filtration and collecting the respective filtrates; c). selecting a fluorescent dye that is capable of interacting with said hydrophobic contaminants and fluorescing; d). adding said dye to said pulp slurry, aqueous suspension and/or filtrates and allowing said dye to interact with said hydrophobic contaminants; e). measuring fluorescence of said dye and correlating said fluorescence with quantity of said hydrophobic contaminants so as to determine the amount of said hydrophobic contaminants within the corresponding size ranges. In one embodiment, in step a), the hydrophobic contaminants comprise, essentially comprise and preferably are microstickies and/or colloidal substance, which may be for example wood resin, stickies, white resin or a combination thereof produced or trapped in the papermaking process. These hydrophobic contaminants are preferably present in a pulp slurry or aqueous suspension as microstickies and colloidal substance. Further, the said pulp slurry can be, for example, recycled pulp, coated broke, deinked pulp, mechanical pulp, high yield pulp, and combinations thereof and the like. The said aqueous suspension can be, for example, cycled white water.

In step b), the pulp slurry or aqueous suspension is subjected to, in turn, primary large particle filtration using a flat sieve and then secondary fine filtration using a quantitative filter paper, thereby respectively obtaining sieve filtrate (for example, P100-mesh screencut, trapped particle size less than 150 μm) and filter paper filtrate (for example, trapped particle size of less than 20 μm) which mainly comprise contaminant particles of different particle sizes. Preferably, the sieve filtrate mainly comprises microstickies and colloidal substance, while the filter paper filtrate mainly comprises colloidal substance with smaller size. As to the microstickies comprised in the sieve filtrate, dispersion or detackification method is generally advantageously used to reduce the amount of the microstickies, with correspondingly adopting suitable dispersants, surfactants and/or detackifiers to perform this chemical treatment. As to the filter paper filtrate, fixation method is generally advantageously used to reduce the amount of the colloidal substance, with correspondingly adopting suitable fixatives or retention aids to perform this chemical treatment.

As described above, the fluorescent dye used in step c) can be any dye capable of dyeing or interacting with the hydrophobic contaminants and simultaneously fluorescing in the pulp slurry, aqueous suspension or filtrate. A person skilled in the art can obviously select a suitable dye according to the common knowledge in production practice. The amount of the fluorescent dye is not essential herein, as long as it is sufficient to emit the fluorescence, which amount is easily determined by a person skilled in the art according to the literature and practical experience. In one preferred embodiment, the fluorescent dye is preferably Nile red. Subsequently, in order to render the fluorescent dye fully bound with the contaminant particles prior to the fluorescence measurement, and ensure the correlation between the fluorescence and the quantity of the contaminants, in step d) the dye and the hydrophobic contaminants are allowed to interact with each other for a sufficient time. Here, the addition position for the dye is not critical. A person skilled in the art can add the fluorescent dye at any position of the pulp slurry, aqueous suspension or filtrate according to the actual operation. Furthermore, a person skilled in the art can readily determine the sufficient time required for the interaction without undue experiments. In one embodiment, the reaction time between the dye (preferably Nile red) and the contaminant particles is 0.5 to 3 minutes. If necessary, for example, before adding to the filtrate, the dye can be premixed with a solvent or dissolved in an organic solvent. The solvent is miscible with water, and is for example methanol, ethanol, propanol, isopropanol, propylene glycol or a combinations thereof.

In step e), the fluorescence of the dye is measured, and the fluorescence value is correlated with the quantity of the hydrophobic contaminants, so as to determine the amount of the hydrophobic contaminants. As the dye is fully bound with the hydrophobic contaminant particles in the pulp slurry, the aqueous suspension or the filtrate, the fluorescence value of the dye reflects the quantity of the contaminant particles, and is therefore correlated to the concentration of the contaminants.

The fluorometric measurement is performed at a pre-set basis, intermittent basis and/or continuous basis. For example, a flow cell can be utilized as a means for measuring the fluorescence of said dye. More specifically, a process for measurement comprises: the addition of one or more fluorescent dyes into the pulp slurry, the aqueous suspension or the filtrate prior to measuring the fluorescence in the flow cell. The measurement of the fluorescence is known in the prior art to a person skilled in the art, and the parameters and operation mode relating to the measurement can be acquired based on limited experiments and practical experiences. For example, one could utilize flow injection analysis and/or sequence injection analysis techniques and the like to carry out the above-referenced measurement process.

In another exemplary embodiment, the fluorometric measurement is performed with a handheld fluorometer. Of course, a fluorescent measurement may be carried out with other types of fluorometers.

The fluorescence measurement instruments should have an excitation wavelength range and an emission wavelength range that match the characteristic wavelength of the selected dye. In one embodiment, the fluorescence measurement instrument used is set to have an excitation wavelength of 475±20 nm and an emission wavelength of greater than 570 nm for Nile Red dye.

After the hydrophobic contaminants are filtered for N times (N≧1) and the dye is added according to steps b) and c), the fluorescence value f₀ of the fluorescent dye in the pulp slurry or the aqueous suspension and the fluorescence value f_{N} of the fluorescent dye after N-time-filtrations are respectively measured according to the above fluorescence measurement method. The initial fluorescence value f₀ is relevant to the total quantity of the contaminants, while f_{N} is relevant to the quantity of the contaminants in the filtrate after N-time-filtrations. Based on this, a person skilled in the art can obviously determine the contaminants size distribution in the filtrate after any times of filtration and quantitatively analyze the category of the contaminants. For example, the fluorescence difference f_{N-1}−f_{N} is relevant to the quantity of the contaminants within the corresponding size range trapped by these two adjacent filtrations.

In more detail, for example, in one preferred embodiment, the fluorescence value f₀ of the fluorescent dye in the pulp slurry or the aqueous suspension, the fluorescence value f₁ of the fluorescent dye in the filtrate after primary large particle filtration (for example, sieve filtrate), and the fluorescence value f₂ of the fluorescent dye in the filtrate after secondary fine filtration (for example, filter paper filtrate) are measured in step e). Furthermore, due to different natures of the sieve filtrate and the filter paper filtrate as described above, the fluorescence difference f₀−f₁ is correlated with the quantity of the macrostickies, the fluorescence difference f₁−f₂ is correlated with the quantity of the microstickies, and the fluorescence value f₂ is correlated with the quantity of the colloidal substance.

Although, as described at the beginning, turbidity measurement in the prior art has certain drawbacks, it is not excluded herein that the turbidity measurement of the filtrate may be performed optionally before, during or after the dye addition (for example, prior to the dye addition) in order to provide supplementary information about a small quantity of hydrophobic contaminant components that are incompatible with the fluorescent dye.

In one preferred embodiment, the inventive method does not comprise a step of turbidity measurement.

In another preferred embodiment, the inventive method consists of the steps a) to e). In the second aspect, the present invention relates to a method of determining chemical treatments for controlling hydrophobic contaminants by using fluorescence technology, comprising the steps a) to e) in the method of determining the quantity of hydrophobic contaminants in a papermaking process by using fluorescent dye as described in the first aspect. The description and the preferred embodiments of these steps have been given above, and they are also applicable to the method of determining chemical treatments for controlling hydrophobic contaminants by using fluorescence technology. The method comprises, after these steps, step f) of optionally carrying out chemical treatments including dispersion, detackification and/or fixation according to the quantities of various hydrophobic contaminants.

In one preferred embodiment, by, for example, respectively measuring the fluorescence values of the filtrate after primary large particle filtration (for example, sieve filtrate) and the filtrate after secondary fine filtration (for example, filter paper filtrate), the information about the amounts of the contaminants such as microstickies and colloidal substance with the corresponding size ranges can be obtained. Based on this, a person skilled in the art can select suitable chemical treatments according to the requirement and the desired effect.

In the above-mentioned preferred embodiment, as described above, the fluorescence difference f₁−f₂ is correlated with the quantity of microstickies, while the fluorescence value f₂ is correlated with the quantity of colloidal substance. Furthermore, the difference between the fluorescence values of two adjacent filtrations can be measured, and then depending on whether this difference is significant or not, one can perform the chemical treatments of dispersion, detackification and/or fixation. For example, if the fluorescence difference f_{N-1}−f_{N} is less than 10 or less than 30 or less than 50 a.u. (herein and elsewhere in the context, “f_{N-1}” or respectively “f_{N}” refers to the fluorescence value as measured after filtering the pulp slurry, the aqueous suspension or the filtrate for N−1 or respectively N times), this difference would be considered as not significant and thus it is believed that the filtrate would comprise the corresponding category of contaminants (for example, microstickies) in a relatively small proportion, so that it would be unnecessary to further reduce the concentration thereof by using chemical treatments such as detackification or dispersion or it would be meaningless to use such chemical treatments. For another example, if the fluorescence difference f_{N-1}−f_{N} is significant, one can determine the relative amount of the corresponding category of contaminants (for example, microstickies or colloidal substance) and thereby consider adopting chemical treatments such as dispersion, detackification and/or fixation to reduce the quantities of different categories of contaminants. As should be understood by a person skilled in the art, the expression “whether the fluorescence difference is significant or not” depends on the operation experiences after multiple implementation of the method of the present invention as well as the production cost and the desired removal effect.

Further, according to the quantities of the microstickies and colloidal substance as determined respectively from the fluorescence values f₁−f₂ and f₂, a person skilled in the art can determine, more accurately, whether or not to apply a dispersant, surfactant, detackifier for the microstickies, and whether or not to apply a fixative, retention aid for the colloidal substance.

In one embodiment, the method consists of the steps a) to f).

A third aspect of the present invention is to provide for a method of optimizing the dosage of treatment chemicals for reducing the overall quantity of hydrophobic contaminants by using fluorescence technology, comprising the steps of: a). obtaining a pulp slurry or an aqueous suspension containing hydrophobic contaminants from paper- & pulp-making process; b). subjecting the pulp slurry or aqueous suspension to at least primary large particle filtration and/or secondary fine filtration and collecting the respective filtrates; c). selecting a fluorescent dye that is capable of interacting with said hydrophobic contaminants and fluorescing; d). adding said dye to said pulp slurry, aqueous suspension and/or filtrates, and allowing said dye to interact with said hydrophobic contaminants; e). measuring fluorescence of said dye and correlating said fluorescence with quantity of said hydrophobic contaminants, so as to determine the amount of said hydrophobic contaminants within the corresponding size ranges; f). adding one or more dispersants, detackifiers and/or fixatives to said pulp slurry, aqueous suspension and/or filtrates; g). repeating steps a)-e) for at least one time to re-determine the quantity change of the hydrophobic contaminants (for example, microstickies and/or colloidal substance) within the corresponding size ranges in said pulp slurry, aqueous suspension and/or filtrates, and then optionally controlling and adding said one or more dispersants, detackifiers and/or fixatives with a changed amount to said pulp slurry, aqueous suspension and/or filtrates. The description and the preferred embodiments of the steps a) to f) have been given above, and they are also applicable to the method of optimizing the amount of treatment chemicals for reducing the overall amount of hydrophobic contaminants by using fluorescent dye.

As described above, after determining the chemical treatment to be used and the treatment chemicals useful for performing the chemical treatment of dispersion, detackification and/or fixation by correlating the fluorescence values to the quantities of the contaminants with different size ranges, one can attempt to further optimize the dosage of the treatment chemicals by repeating the above steps.

Therefore, in case that the hydrophobic contaminants would be filtrated for N (N≧1) times in step b, a person skilled in the art would readily appreciate by referring to the above contents, that after determining the treatment manner the corresponding treatment chemicals may be added and the quantity reduction of the targeted contaminants after each addition may be measured, that is the reduction in the fluorescence value Δ_{(f(N-1)-f(N))}=[(f_{(N-1)(0)}−f_{(N(0)})−(f_{(N-1)(n)}−f_{N(n)})]/[f_{(N-1)(0)}−f_{N(0)}]×100% corresponding to the quantity reduction of the targeted contaminants having the specific size range for which the (N−1)^{th} filtration and the N^{th} filtration are performed, or the reduction in the fluorescence value Δ_{(f(N))}=[(f_{(N)(0)}−f_{N(n)}]/f_{N(0)}×100% corresponding to the quantity reduction of the finally remained contaminants in the filtrate after the last, i.e. N^{th} filtration, thereby obtaining the dosage of the treatment chemicals corresponding to the desired reduction rate of contaminants as an optimized amount, wherein n designates the times of adding the treatment chemicals and is ≧1, and “f_{(N-1)(0)}” and “f_{N(0)}” respectively designate the fluorescence values after (N−1)^{th} filtration and the N^{th} filtration when no treatment chemicals are added.

In one preferred embodiment, the fluorescence difference f₁−f₂ is correlated to the quantity of microstickies, and the fluorescence value f₂ is correlated to the quantity of colloidal substance. Starting from the first time adding the treatment chemicals, for each addition, the reduction rate of f₁₍ₙ₎−f₂₍ₙ₎ is calculated for microstickies and the reduction rate of f₂₍ₙ₎ is calculated for colloidal substance, and then these two calculated values may be compared respectively with the initial values of f₁₍₀₎−f₂₍₀₎ and f₂₍₀₎. As the reduction rate substantially corresponds to the removal rate of microstickies and colloidal substance, the comparison of the reduction rates can also reflect the efficiency of the treatment chemicals under the given dosage.

In one exemplary embodiment, the initial quantity of microstickies in the initial filtrate without addition of the treatment chemicals is correlated to f₁₍₀₎−f₂₍₀₎, and the initial quantity of colloidal substance in the initial filtrate is correlated to f₂₍₀₎, wherein f₁₍₀₎ and f₂₍₀₎ are respectively the fluorescence values of the filtrate (for example, sieve filtrate) after primary large particle filtration and the filtrate (for example, filter paper filtrate) after secondary fine filtration without addition of the treatment chemicals. After determining the desired chemical treatment, suitable treatment chemicals are selected and added to the paper- & pulp-making process, and after each addition the values of f₁₍ₙ₎−f₂₍ₙ₎ and f₂₍ₙ₎ are measured (wherein f₁₍ₙ₎ and f₂₍ₙ₎ respectively designate the fluorescence values of the filtrate (for example, sieve filtrate) after primary large particle filtration and the filtrate (for example, filter paper filtrate) after secondary fine filtration after the n^{th} addition. According to the following equations (1) and (2), the reduction rate Δ_{(f1-f2)} of (f₁−f₂) is calculated for microstickies and the reduction rate Δ_{(f2)} of (f₂) is calculated for colloidal substance. Then the dosage of the treatment chemicals corresponding to the reduction rate is the optimized addition amount.

Δ_{(f1-f2)}=[(f₁₍₀₎−f₂₍₀₎)−(f₁₍ₙ₎−f₂₍ₙ₎)]/(f₁₍₀₎−f₂₍₀₎)×100% (1)

Δ_{(f2)}=[(f₂₍₀₎−f₂₍ₙ₎]/f₂₍₀₎×100% (2)

A person skilled in the art can investigate the improvement in the contaminants removal rate for example by addition of the corresponding treatment chemicals in substantially equally increased amount for n times, and then adjust the dosage of the treatment chemicals corresponding to different contaminants removal rate (i.e., corresponding to different Δ_{(f1-f2)} or Δ_{(f2)}) according to the requirement (e.g. cost and time), thereby obtaining the most suitable optimized dosage.

Although, theoretically, the treatment chemicals can be added in such a dosage as to achieve a removal rate as high as possible, in view of practical experience and cost accounting, the blind pursuit of high removal rate may be unnecessary. In one preferred embodiment, the reduction rates Δ_{(f1-f2)} and Δ_{(f2)} are not less than 10%, preferably not less than 30%, more preferably not less than 50%, particularly preferably not less than 60%, most preferably not less than 70% or 80%. A person skilled in the art can, for example, utilize the dosage of the treatment chemicals corresponding to the above preferred reduction rates Δ_{(f1-f2)} and Δ_{(f2)} as the optimized dosage.

### EXAMPLES

The following examples are used to illustrate the present invention in more detail, but the present invention is not limited to these examples.

### Example 1

Three different pulp slurries of native hardwood pulp (LBKP), recycled deinked pulp (DIP) and high yield mechanical pulp (BCTMP) were respectively experimented to determine the amount of hydrophobic contaminants in various pulp slurries. Furthermore, the individual amounts of macrostickies, microstickies and colloidal substance comprised therein were analyzed according to the measured fluorescence values.

When testing each pulp slurry, the selected Nile Red dye was firstly added to the slurry to be tested, then the unfiltered aqueous suspension, the sieve filtrate and the filter paper filtrate were respectively collected, and finally the fluorescence of Nile Red was measured. As shown in Table 1, among these three pulp slurries, the high yield mechanical pulp had the highest fluorescence f₀, followed by the recycled deinked pulp, and the native hardwood pulp had the smallest fluorescence. This indicated that the high yield mechanical pulp and the recycled deinked pulp had a relatively high total quantity of hydrophobic contaminants, while the native hardwood pulp had very little hydrophobic contaminants. With respect to the contaminants particle size distribution analysis, the colloidal substance had the highest amount in all these three pulp slurries, followed by the microstickies, and the macrostickies had the least amount. Obviously, the test results also showed that various pulp slurries were markedly different in terms of the category and composition of the contaminants.

TABLE 1
Determination of quantity and composition of hydrophobic contaminants
in different pulp slurries by using fluorescent dye

| | | | | Macro- | Micro- | Colloidal |
|---|---|---|---|---|---|---|
| | Fluorescence (a.u.) | | | stickies | stickies | substance |
| | f₀ | f₁ | f₂ | f₀-f₁ | f₁-f₂ | f₂ |
| LBKP | 31.2 | 29.3 | 24.4 | 1.9 | 4.9 | 24.4 |
| DIP | 147.4 | 132.9 | 102.1 | 14.5 | 30.8 | 102.1 |
| BCTMP | 451.4 | 445.5 | 418.6 | 5.9 | 26.9 | 418.6 |

Note:
1. f₀, f₁, f₂ is the fluorescence of the unfiltered aqueous suspension, the sieve filtrate (100 mesh, sieve slit 150 μm) and the filter paper filtrate (trapped particle size 20 μm) respectively.

### Example 2

Two different grades of high yield mechanical pulp (BCTMP) A and B were respectively experimented, to screen out the specific control program for their respective target contaminants.

In the course of testing, a sieve was used to perform primary large particle filtration and a filter paper was used to perform secondary fine filtration, followed by adding the selected Nile Red to the collected sieve filtrate and filter paper filtrate, and finally the fluorescence was measured.

For high yield mechanical pulp A, as shown in Table 2, the fluorescence values of the sieve filtrate and the filter paper filtrate were not significantly different from each other, as indicated that the hydrophobic contaminants comprised in the high yield mechanical pulp A were mainly fine colloidal contaminants and microstickies or larger particles were substantially absent. Therefore, it could be determined that the BCTMP slurry only needed to undergo a chemical treatment of fixation. In addition to fluorescence test, filtrate turbidity was also tested for the purpose of method comparison. However, turbidity method provided little useful information helping to determine a suitable chemical treatment. The fixative HYBRID™ 61755 was used for a chemical treatment of the high yield mechanical pulp A, and the paper filtrate turbidity and the dye fluorescence were measured after each treatment. At this time, both paper filtrate turbidity and fluorescence trend to decline. Supposed that the desired removal rate was not less than 70%, according to the results of fluorescence measurement in Table 1, the fixative 61755 should be added in a dosage of 1.0 kg/ton bone dry pulp to treat the contaminants in the pulp slurry.

TABLE 2
Optimizing contaminants controlling program for high yield mechanical pulp A

| | | | | % | | | | % |
|---|---|---|---|---|---|---|---|---|
| | Filtrate turbidity (NTU) | | | Reduction | Fluorescence (a.u.) | | | Reduction |
| | T₁ | T₂ | T₁-T₂ | of T₂ | f₁ | f₂ | f₁-f₂ | of f₂ |
| Blank | 313 | 196 | 117 | 0.0 | 460.8 | 463.3 | −2.5 | 0.0 |
| 61755_0.2 kg | 212 | 133 | | 32.1 | 371.5 | 378.2 | | 18.4 |
| 61755_0.5 kg | 152 | 80 | | 59.2 | 314.2 | 244.9 | | 47.1 |
| 61755_1.0 kg | 86 | 60 | | 69.4 | 147.3 | 123.0 | | 73.5 |
| 61755_1.5 kg | 65 | 22 | | 88.8 | 131.1 | 77.1 | | 83.4 |

Note:
1. T₁, T₂ is the turbidity of the sieve filtrate (100 mesh, sieve slit 150 μm) and the filter paper filtrate (trapped particle size 20 μm) respectively;
2. f₁, f₂ is the fluorescence of the sieve filtrate and the filter paper filtrate respectively.

For high yield mechanical pulp B, as seen from the fluorescence results of Nile Red in the sieve filtrate and the filter paper filtrate as shown in Table 3, 14% of overall contaminants were microstickies (ex. (f₁−f₂)/f₁×100%) and the rest 86% were colloidal substance (ex. f₂/f₁×100%). Therefore, a dual program of detackifier 62520 and fixative HYBRID™ 7527 was determined for treatment of the high yield mechanical pulp B. According to the experimental data in Table 3, in case the dosage of detackifier 62520 was more than 3.0 kg/ton bone dry pulp, the reduction rate change Δ_{(f1-f2)} of (f₁−f₂) as measured became no longer significant, thereby stopping repeatedly addition of detackifier 62520. Likewise, in case that the dosage of fixative 7527 was 0.8 kg/ton bone dry pulp, the repeated addition of fixative 7527 was also stopped in view of cost and removal rate that had met the requirement of optimization. Finally, according to the fluorescence results, the optimized contaminants controlling program for the high yield mechanical pulp B was determined as follows: adding detackifier 62520 in the dosage of 2.0 to 3.0 kg/ton bone dry pulp and simultaneously fixative 7527 in the dosage of 0.8 kg/ton bone dry pulp. Likewise, as shown in Table 3, the turbidity of the high yield mechanical pulp B was also measured, but the turbidity method provided little useful information helping to design the treatment program.

TABLE 3
Optimizing contaminants controlling program for high yield mechanical pulp B

| | | | | % | % | | | | % | % |
|---|---|---|---|---|---|---|---|---|---|---|
| | Filtrate turbidity (NTU) | | | Reduction | Reduction | Fluorescence (a.u.) | | | Reduction | Reduction |
| | T₁ | T₂ | T₁-T₂ | of T₁-T₂ | of T₂ | f₁ | f₂ | f₁-f₂ | of f₁-f₂ | of f₂ |
| Blank | 246 | 110 | 136 | −16.2 | 0.0 | 458.5 | 395.4 | 63.1 | 0.0 | 0.0 |
| 62520_0.5 kg | 310 | 123 | 187 | −59.8 | | 482.1 | 420.0 | 62.1 | 1.6 | |
| 62520_1.0 kg | 238 | 137 | 101 | 13.7 | | 485.7 | 437.0 | 48.7 | 22.8 | |
| 62520_1.5 kg | 232 | 135 | 97 | 17.1 | | 483.8 | 448.1 | 35.7 | 43.4 | |
| 62520_2.0 kg | 246 | 136 | 110 | 6.0 | | 483.1 | 457.3 | 25.8 | 59.1 | |
| 62520_3.0 kg | 232 | 140 | 92 | 21.4 | | 490.4 | 469.5 | 20.9 | 66.9 | |
| 7527_0.4 kg | 99 | 40 | | | 63.6 | 238.1 | 174.3 | | | 55.9 |
| 7527_0.8 kg | 50 | 18 | | | 83.6 | 150.9 | 109.0 | | | 72.4 |

Note:
1. T₁, T₂ is the turbidity of the sieve filtrate (100 mesh, sieve slit 150 μm) and the filter paper filtrate (trapped particle size 20 μm) respectively;
2. f₁, f₂ is the fluorescence of the sieve filtrate and the filter paper filtrate respectively.

### Example 3

The contaminants controlling program in recycled deinked pulp (DIP) was screened and optimized by using fluorescent dye method. As seen from the fluorescence results of Nile Red in the sieve filtrate and the filter paper filtrate as shown in Table 4, 8% of overall contaminants were microstickies (ex. (f₁−f₂)/f₁×100%) and the rest 92% were colloidal substance (ex. f₂/f₁×100%). Therefore, using a combination of two or more chemical treatments was needed for treating the recycled deinked pulp, i.e. using a detackifier or a dispersant to reduce the quantity of microstickies and simultaneously a fixative to reduce the quantity of the colloidal substance. The fluorescence method was used to further screen out the optimal treatment chemicals. As shown in Table 4, the microstickies-removal efficiency of detackifier DVP4O004 was superior to that of detackifier 62520 and dispersant 8683, while the colloidal substance-removal efficiency of fixative 7655 was superior to that of fixatives HYBRID™ 7527 and 61755. Therefore, if the removal rate of hydrophobic contaminants was required not less than 80% for the purpose of overall control, the optimized chemical treatment program was determined as follows: adding detackifier DVP4O004 in the dosage of 0.8 kg/ton bone dry pulp and simultaneously fixative 7655 in the dosage of 0.5 kg/ton bone dry pulp.

TABLE 4
Screening and optimizing contaminants controlling
program for recycled deinked pulp

| | | | | % | % |
|---|---|---|---|---|---|
| | Fluorescence (a.u.) | | | Reduction | Reduction |
| | f₁ | f₂ | f₁ − f₂ | of f₁ − f₂ | of f₂ |
| Blank | 928 | 857 | 71.0 | 0.0 | 0.0 |
| DVP4O004_0.4 KG | 902 | 880 | 22.0 | 69.0 | |
| DVP4O004_0.8 KG | 889 | 872 | 17.0 | 76.1 | |
| DVP4O004_1.5 KG | 873 | 872 | 1.0 | 98.6 | |
| 62520_0.4 KG | 888 | 858 | 30.0 | 57.7 | |
| 62520_0.8 KG | 878 | 853 | 25.0 | 64.8 | |
| 62520_1.5 KG | 899 | 881 | 18.0 | 74.6 | |
| 8683_0.8 KG | 918 | 870 | 48.0 | 32.4 | |
| 8683_1.5 KG | 898 | 870 | 28.0 | 60.6 | |
| 7655_0.2 KG | | 333 | | | 61.1 |
| 7655_0.5 KG | | 137 | | | 84.0 |
| 7527_0.2 KG | | 384 | | | 55.2 |
| 7527_0.5 KG | | 193 | | | 77.5 |
| 61755_0.2 KG | | 371 | | | 56.7 |
| 61755_0.5 KG | | 180 | | | 79.0 |

Note:
1. f₁, f₂ is the fluorescence of the sieve filtrate (100 mesh, sieve slit 150 μm) and the filter paper filtrate (trapped particle size 20 μm) respectively.

As can be seen from the above examples, the fluorescence method according to the present invention was more practical than the turbidity method in the prior art. Furthermore, the method according to the present invention could be used for rapidly and purposively designing the chemical treatment and optimizing the dosage of the corresponding treatment chemicals to be used.

1. A method of quantifying hydrophobic contaminants in a papermaking process comprising:
subjecting a pulp slurry or aqueous suspension to primary large particle filtration and/or secondary fine filtration;
selecting a dye that is capable of interacting with the hydrophobic contaminants and fluorescing upon the interaction;
adding the dye to the pulp slurry, aqueous suspension and/or filtrates, and allowing the dye to interact with the hydrophobic contaminants, thereby resulting in fluorescence; and
measuring the fluorescence and correlating the fluorescence with the quantity of the hydrophobic contaminants in the pulp slurry, aqueous suspension and/or filtrates.

2. The method of claim 1, wherein the dye is selected from Nile red, dansyl amine, pyrene, 1-pyrene formaldehyde, 2,6-diphenyl-4-(2,4,6-triphenyl-1-pyridinium)phenolate, 4-aminophthalimide, 4-(N,N-dimethylamino)phthalimide, bromonaphthalene, 2-dimethylaminonaphthalene and combinations thereof.

3. The method of claim 1, wherein the pulp slurry or aqueous suspension is subjected to each of primary large particle filtration and secondary fine filtration.

4. The method of claim 3, wherein the primary large particle filtration and the secondary fine filtration each have filter mesh sizes, and the filter mesh size of the primary large particle filtration is greater than 30 μm larger than the filter mesh size of the secondary fine filtration.

5. The method of claim 1, wherein the hydrophobic contaminants comprise at least one of macrostickies, microstickies and colloidal substance.

6. The method of claim 1, wherein the dye is added to the pulp slurry or aqueous suspension, and the fluorescence has a fluorescence value f₀ in the pulp slurry or aqueous suspension and a fluorescence value f_{N} after N-times-filtration (N≧1).

7. The method of claim 6, wherein a fluorescence difference f_{N-1}−f_{N} is correlated to the quantity of the hydrophobic contaminants having a corresponding size range filtered from adjacent filtrations.

8-9. (canceled)

10. The method of claim 1, further comprising:
treating the pulp slurry or aqueous suspension with a chemical treatment.

11-14. (canceled)

15. The method of claim 10, wherein the treatment of the pulp slurry or aqueous suspension is controlled so as to reduce the quantity of the hydrophobic contaminants in the primary and/or secondary filtrate.

16-17. (canceled)

18. The method of claim 10, further comprising:
repeating the adding, the measuring, and the treating steps.

19-27. (canceled)

28. The method of claim 1, wherein the pulp slurry or aqueous suspension comprises at least one of native hardwood pulp, recycled deinked pulp, and mechanical pulp.

29. The method of claim 1, wherein the pulp slurry or aqueous suspension comprises recycled deinked pulp.

30. The method of claim 1, wherein the pulp slurry or aqueous suspension comprises mechanical pulp.

31. The method of claim 30, wherein the mechanical pulp comprises high yield mechanical pulp.

32. The method of claim 10, wherein the chemical treatment comprises a component selected from a dispersant, a surfactant, a detackifier, a fixative, and a retention aid, and combinations thereof.

33. The method of claim 10, wherein the chemical treatment comprises a fixative.

34. The method of claim 18, wherein the chemical treatment comprises a fixative.

35. The method of claim 28, wherein the chemical treatment comprises a fixative.

36. The method of claim 29, wherein the chemical treatment comprises a fixative.

37. The method of claim 30, wherein the chemical treatment comprises a fixative.
